(19) United States
(12) Patent Application Publication
(10) Pub. No.: US 2005/0216897 A1
(43) Pub. Date: Sep. 29, 2005

(54) Converter, automation device with a converter, and a development environment having an automation device with converter

(75) Inventors: Armin Amrhein, Kuemmersbruck (DE); Klaus Goebel, Bruchsal (DE); Ulrich Goeddemeier, Karlsruhe (DE); Bernhard Jany, Wendelstein (DE); Werner Kuske, Neuenbuerg (DE); Thilo Opaterny, Nuernberg (DE); Manfred Prechtl, Schwarzenfeld (DE); Georg Rupprecht, Nuemberg (DE); Dietmar Schulz, Rosstal (DE); Lothar Trapp, Feucht (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 11/047,661

(22) Filed: Feb. 2, 2005

Related U.S. Application Data
(63) Continuation of application No. PCT/DE03/02594, filed on Aug. 1, 2003.

(30) Foreign Application Priority Data
Aug. 2, 2002 (DE) 102 35 504.5

(51) Int. Cl. G06F 9/45

(52) U.S. Cl. 717/136

(57) ABSTRACT

A converter (51) for generating a control program (17) running on target hardware based on a primary code with a plurality of instructions (22, 31), an automation device (11) with such a converter (51) and a development environment with such an automation device (11) with access to a database (52). In the database, a transformation rule (53) is stored for each instruction (22, 31), with functionality (54, 55, 56) for supplementing each instruction (22, 31), such that each parameter (36-40), which is used and/or influenced by the instruction (22, 31), can be logged. The transformation rule (53) includes information for supplementing the instruction (22, 31) with respect to the logging of each parameter (36-40).

This is a Continuation of International Application PCT/DE2003/002594, with an international filing date of Aug. 1, 2003, which was published under PCT Article 21(2) in German, and the disclosure of which is incorporated into this application by reference.

### FIELD AND BACKGROUND OF THE INVENTION

1. Field of the Invention

The present invention relates to monitoring control programs. In particular, the present invention relates to monitoring control programs used to control and/or monitor technical processes.

2. Description of Related Art

For the monitoring of control programs, e.g., for their startup or maintenance, the use of so-called debuggers is generally known in the art. A debugger makes it possible, for example, to run a control program step by step, such that, out of the plurality of individual instructions that make up a control program, always one instruction after another is executed. The effect of executing each individual instruction can then be monitored. This monitoring capability relates not only to the changes in the display screen content or the changes in the state of the technical process caused by each instruction but also to the contents of registers, e.g., processor registers, of the respective target hardware on which the control program is run.

This debugger is typically used on the same target hardware as the control program itself. If the debugger cannot be executed on the target hardware because the resources, e.g., memory space, computing capacity, etc., of the target hardware are limited, the debugger is executed on a programming or monitoring device that is connected to the target hardware for communication. The debugger then accesses data that are provided for the purpose of monitoring the control program.

The capacity of a debugger ranges from simple monitoring functions, where only the effects of the individual instructions can be displayed, to complex influencing capabilities, where the execution of the control program can be influenced, for example, by changing individual memory or register contents. To execute a debugger for such complex functions, a computer, such as a personal computer, a programming device or the like is used. For simple monitoring functions, however, a monitoring device, which is provided to display the respective data, i.e., a computer with reduced capacity, e.g., without storage means and input means, but with at least one output device, such as a display screen or a printer, is sufficient. Such programming or monitoring devices are hereinafter collectively referred to as programming device(s).

The German Laid Open Publication EP 0 990 964 A1 discloses a method for operating an automation system with a programming device and with target hardware in the form of an automation device. In this method, the target hardware provided for controlling and/or monitoring a technical process can be monitored with the programming device. This programming device is provided for controlling and monitoring the automation device. To control and monitor the automation device, one or more data addresses of the control program and a code address for each data address selected for monitoring are selected in the programming device. The programming device transmits these addresses to the target hardware using a request message. When the code address is received in the target hardware, the content of the associated data address(es) is recorded and transmitted to the programming device as part of a result message. This type of monitoring of a control program is also referred to as “remote debugging.”

The drawback of the known monitoring method and/or the known debuggers is that, on the one hand, not all of the information is always accessible, e.g., because the storage location of possible intermediate results is unknown. On the other hand, individual items of information—e.g., for indirectly referenced parameters—can be accessed only with considerable effort. For example, in a typical add statement in the form “add the content of the memory address FF03 to the content of the accumulator,” the display of the respective memory area must be selected manually. In remote debugging, content of the respective memory area is either not accessible at all or is accessible only with considerable effort partly because in remote debugging, the target hardware processor executing the control program to be monitored is not stopped during the debugging. Consequently, the content of individual memory addresses cannot be “looked up.”

Finally, when control programs are used that are provided to run on various types of target hardware, the structure and capacity of the actual target hardware is unknown. One and the same control program can thus be executed on target hardware with a standard microprocessor, e.g., with eight processor registers, or on target hardware with a special ASIC instead of the microprocessor, with a plurality of special registers. When an add statement of the control program, for example, is executed on the target hardware with the microprocessor, different registers are influenced than when it is executed on the target hardware with the ASIC. Thus, the monitoring or programming device for monitoring the execution of the control program does not know which registers of the target hardware are used or influenced when the add statement is executed. In fact, the monitoring or programming device does not even know how the respective target hardware executes the add statement. Differences can result if, for example, the microprocessor can at maximum directly execute additions of the contents of 32-bit registers, whereas the ASIC can directly execute additions of the contents of 64-bit registers. When the add statement is executed, an addition of parameters of a respective size must be broken down into two partial additions, whereas in the ASIC the addition can be executed directly.

### OBJECTS OF THE INVENTION

One object of the present invention is to obviate the aforementioned drawbacks and to provide a way to monitor the execution of a control program on a target hardware that is not known in advance.

Illustrative, non-limiting embodiments of the present invention may overcome the above disadvantages and other disadvantages not described above. The present invention is not necessarily required to overcome any of the disadvantages described above, and the illustrative, non-limiting embodiments of the present invention may not overcome any of the problems described above. The appended claims should be consulted to ascertain the true scope of the invention.

### SUMMARY OF THE INVENTION

According to an illustrative, non-limiting formulation of the present invention, a converter is provided. The converter generates a control program is configured to run on a target hardware. The control program is based on a primary code with a number of instructions. To generate the control program, the converter has access to a database in which a transformation rule is stored for each permissible instruction of the primary code. The converter completes or supplements each instruction such that each parameter is logged. These parameters are or can be used and/or influenced by the respective instruction. To log these parameters which correspond to the instruction being supplemented, the transformation rule includes information to supplement the instruction with respect to the logging of the respective parameters. The information is evaluated accordingly by the converter.

Parameters influenced by an instruction are, in particular, the individual operands of the respective instruction. These include, for example, in the case of an addition, not only the two addends but also register and memory contents and so-called flags, to the extent that they are used or influenced when the instruction is executed.

In the exemplary, non-limiting formulation of the present invention, it is recognized that when the executable control program is generated from the underlying primary code, a source code or an intermediate code obtained therefrom, all of the information necessary for subsequent complete monitoring of the execution of the control program is available.

If, for example, an addition of two parameters relates to two integers stored in the memory, the add statement “a+b” in a pseudo code reads as follows, for example:
Load the content of the memory location where the parameter “a” is stored into a register.
Add to the content of this register the content of the memory location where the parameter “b” is stored.

After these two instructions are executed, this register contains the sum of the parameters “a” plus “b.” The register is, for example, the so-called accumulator, which is frequently used for additions and similar operations.

From the pseudo code, shown above by way of example, it is apparent that the parameter “b” cannot be monitored directly. After the first line of the pseudo code is executed, the register contains the value of the parameter “a.” The content of the register could be displayed for monitoring purposes. After the second line of the pseudo code is executed, however, the register contains the sum of the two parameters “a” plus “b.” Therefore, the parameter “b” can not be monitored directly. The value of the parameter “b” can be accessed only by looking up the content of the memory location where the parameter “b” is stored. A look up of the content of the memory location of the parameter “b” requires considerable effort. The effort is even greater if an indirect addressing of the respective memory locations is used.

When the control program is generated, however, all of the information required for the subsequent monitoring of the control program is available. The non-limiting formulation of the present invention therefore provides for the logging of each parameter, which can be used and/or influenced by the instruction. To log each parameter of the individual instructions, the individual instructions of the primary code underlying the control program are analyzed. Thus, the above pseudo code used as the primary code should further read, for example:
Load the content of the memory location where the parameter “a” is stored into a register, and
log the content of the register.
Add to the content of the register the content of the memory location where the parameter “b” is stored, and
log the content of the memory location where the parameter “b” is stored, and log the content of the register.

The indented passages of the pseudo code above contain the additions with respect to the logging of the parameters used in the control program.

Based on the transformation rule for converting each instruction of the primary code, it is known how the data of the individual parameters influenced by the instruction can be reached. In the present example, the transformation rule includes the conversion of the add statement into two separate instructions. The information to log the respective parameters, which is associated with, or contained in the transformation rule, indicates that, for example, in case of an addition, the value of the first addend, the parameter “a,” does not need to be looked up again in the memory, but that the content of the register can be logged directly because the value of the parameter “a” was copied into the register. With respect to the actual addition part, the supplemental information indicates that no register contains the value of the parameter “b” at any time. Accordingly, the logging relates to the memory location where the parameter “b” is stored.

On different target hardware, the same add statement can be executed differently if operations with three operands are permitted, for example. For this target hardware, for example, the add statement in a pseudo code reads as follows:
Add the contents of the memory locations where the parameter “a” and the parameter “b” are stored and load the result into a register.

In this variant neither of the parameters “a” or “b” is stored in a register at any time. Logging, therefore, relates to the respective memory location in every case. The completed instruction therefore reads as follows, for example:
Add the content of the memory locations where the parameter “a” and the parameter “b” are stored and load the result into a register, and
log the content of the memory locations where the parameters “a” and “b” are stored, and
log the content of the register.

This instruction described in the block above shows that the capability of monitoring the control program becomes completely independent of how the parameters are used. Thus, it is not necessary to know the functionality of the target hardware or even the target hardware itself in order to be able to monitor the control program.

As a result, the non-limiting formulation of the present invention is also particularly suitable for applications where a source code is first transformed into an intermediate language. With the aid of this intermediate language as the primary code, a conversion into a control program executable on a specific piece of target hardware is then possible. As a result, independence of the respective hardware is achieved. If a first piece of target hardware is subsequently replaced with, or upgraded to, a second piece of hardware, only a conversion of the intermediate language into the machine code executable by the respective target hardware is required. This conversion can optionally be performed even by the respective target hardware itself. After the control software is generated in a suitable programming language, the source code thus available is transformed into the intermediate language. The control program in the intermediate language can then be executed in the target hardware following a conversion based on the respective target hardware.

Advantageously, in the exemplary formulation of the present invention, the monitoring capabilities are expanded with respect to information that was previously inaccessible or accessible only with considerable effort. In addition, despite widely different or previously unknown target hardware, the ability of monitoring the control program running on this target hardware is preserved.

In connection with the illustrative formulation of the present invention, or preferred embodiments thereof, the terms below are used as follows: The term “automation device” denotes the hardware used to control and/or monitor the respective technical process, that is, the target hardware. The term automation device can mean both a single device, e.g., a programmable controller or the like, and a combination of several of these devices, e.g., programmable controllers which are connected to communicate with each other and with a master computer and to which decentralized peripheral devices are connected.

The term “control program” denotes, the executable version of the control program, which is provided in a machine code, for example. More generally, however, the term control program in principal refers to all embodiments of the control program, i.e., the control program in the source code, as generated by a programmer in a respective programming language, the control program in an intermediate language, intermediate code, resulting from a transformation of the source code, and the control program in a form suitable to run on the target hardware resulting from a conversion of the control program written in the intermediate language or from a direct conversion of the source code into a machine language.

### BRIEF DESCRIPTION OF THE DRAWINGS

The present invention will now be described in detail by describing an illustrative, non-limiting embodiment thereof with reference to the accompanying drawings. In the drawings, the same reference characters denote analogous elements:

FIG. 1 illustrates a development environment with an automation device as the target hardware and a programming device in accordance with an exemplary, non-limiting embodiment of the present invention,

FIG. 2 schematically illustrates the generating of a control program according to the exemplary embodiment of the present invention,

FIG. 3 is a detail from a source code underlying the control program according to the illustrative embodiment of the present invention,

FIG. 4 shows a combined add and assign statement as an example of an instruction in the source code according to an illustrative, non-limiting embodiment of the present invention,

FIG. 5 shows an intermediate code instruction based on the combined add and assign statement according to the exemplary embodiment of the present invention, and

FIG. 6 shows a converter for converting the or each intermediate code instruction into an executable form and for completing the instruction such that the or each parameter, which is or can be used and/or influenced by the instruction, can be logged according to the exemplary embodiment of the present invention.

### DETAILED DESCRIPTION OF ILLUSTRATIVE, NON-LIMITING EMBODIMENTS

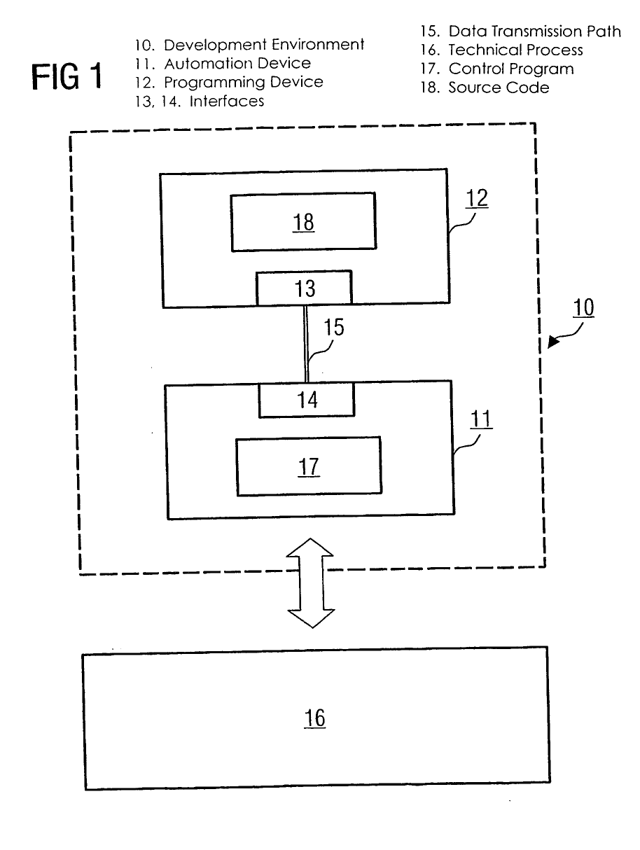

FIG. 1 illustrates a development environment 10 with an automation device 11 as the target hardware and a programming device 12. The automation device 11 and the programming device 12 are interconnected to communicate with each other via their respective interface 13 and 14 and a data transmission path 15. The data transmission path 15 is, for example, any electrically conductive connection between the automation device 11 and the programming device 12. That is, for example, the electrically conductive connection can be a serial connection or a bus (segment), particularly, a field bus (segment). The data transmission path 15 may also be a connection using optical or electromagnetic signals. That is, for example, the optical or electromagnetic signal connection can be an optical fiber cable or the like, or a (line-of-sight) radio link.

The automation device 11 is provided, e.g. in a known manner, for the control and/or monitoring of a technical process 16, which is depicted only schematically in FIG. 1. The technical process 16 is controlled and/or monitored according to a control program 17 executed by the automation device 11. For example, the automation device 11 is a programmable controller, a process computer or some other standard computer suitably configured for influencing the technical process 16.

The programming device 12 is usually adapted and provided for generating or modifying a source code 18 underlying the control program 17. A separate programming device 12 is typically provided because the peripheral devices in the form of at least one input and output device, such as a keyboard or a display screen (not depicted) are required to generate or modify the source code 18. These peripheral devices do not usually exist on the automation device 11 because they are needed only intermittently, i.e., while the source code 18 is generated or modified, and often are also not suitable to permanently remain in hostile industrial environments. Nevertheless, there are automation devices 11 with an integrated programming device 12. For devices of this type, the description provided below also applies.

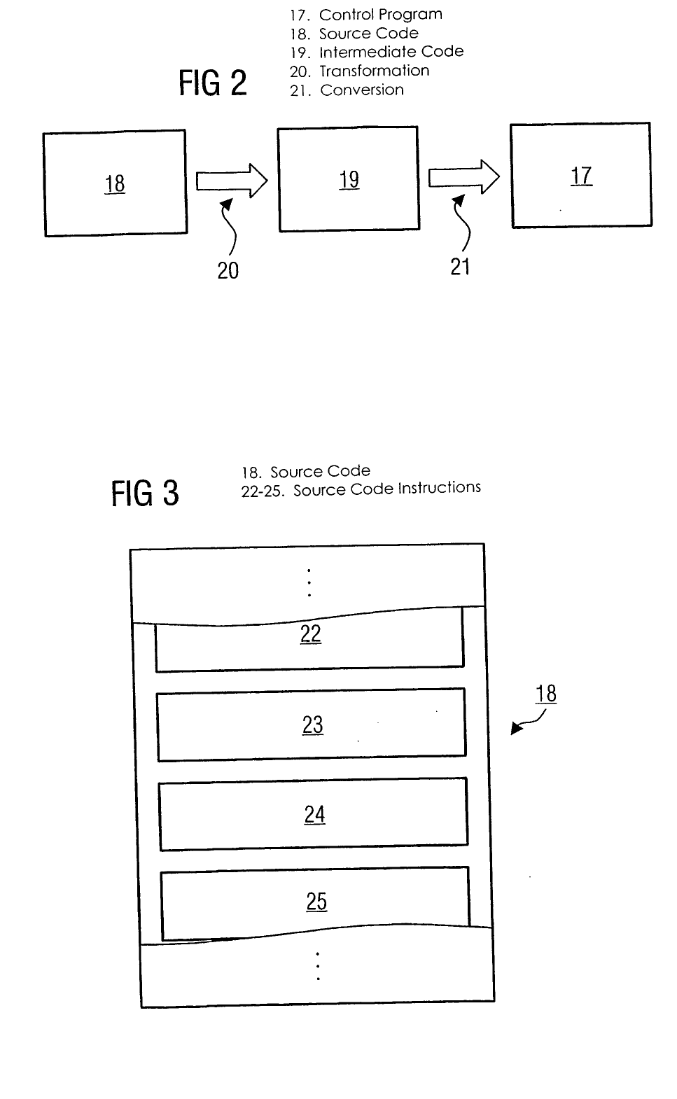

FIG. 2 schematically illustrates the generation of the control program 17. The source code 18 is used to generate an intermediate code 19 and this intermediate code 19 is used to generate the control program 17. The intermediate code 19 is generated by transformation 20 of the source code 18 into a meta language or intermediate language. The control program 17 is generated by conversion 21 of the intermediate code 19 into a form executable on the respective target hardware, i.e., the automation device 11.

FIG. 3 schematically shows a detail of the source code 18 underlying the control program 17. The source code 18 has a plurality of successive source code instructions 22, 23, 24, 25, in a known manner. The respective source code instructions 22-25 and their sequence determine the functionality of the subsequent control program 17. The source code instructions 22-25 include, for example, load and transfer statements, statements for executing arithmetic or logic functions, compare statements, GOTO statements, etc., and, optionally, combined statements of the above described types.

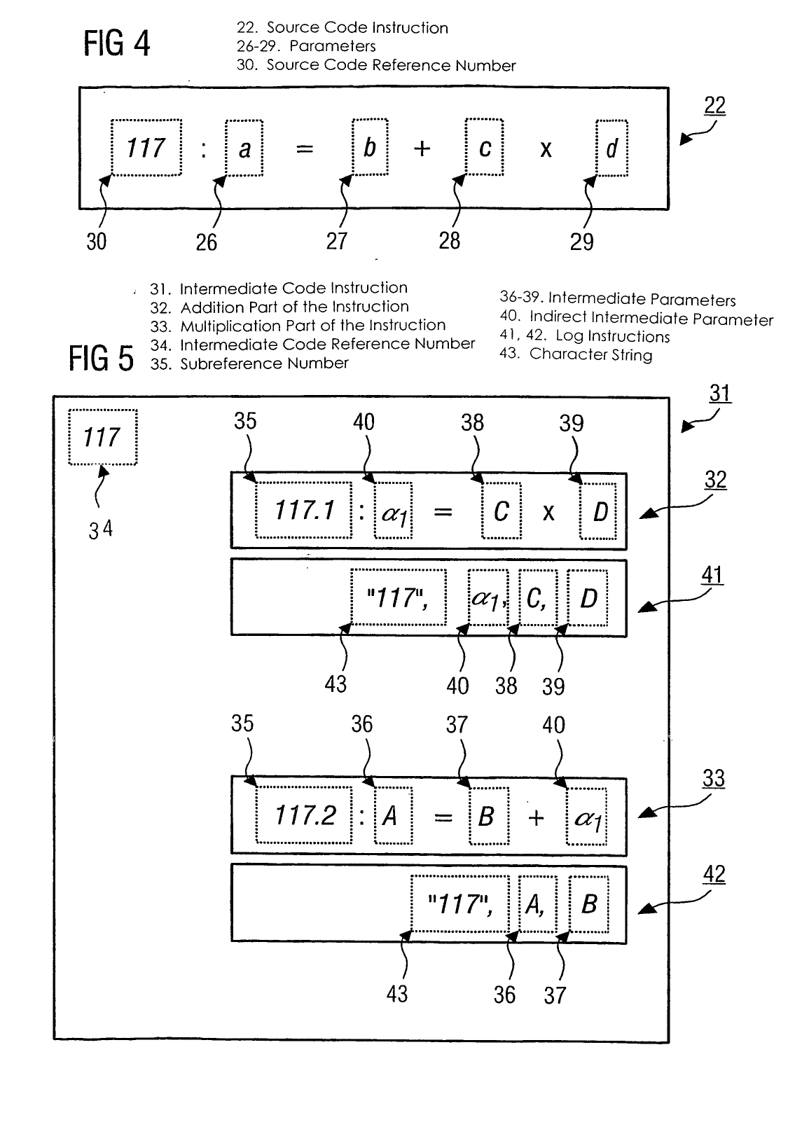

As an example of a source code instruction 22-25, FIG. 4 shows a source code instruction 22 with a combined add, multiply and assign statement “a=b+cxd.” The source code instruction 22 includes a number of parameters. That is, the exemplary source code parameters are: “a” indicated with a numeric reference 26, “b” indicated with a numeric reference 27, “c” indicated with a numeric reference 28 and “d” indicated with a numeric reference 29. A multiplication part of the source code instruction 22 relates to the multiplication of the source code parameters “c” 28 and “d” 29. An addition part of the source code instruction 22 relates to the addition of the source code parameter “b” 27 and the intermediate result of the multiplication part. Finally, an assignment part of the source code instruction 22 relates to the assignment of the result of the above-described addition to the source code parameter “a” 26.

To uniquely identify and reference each source code instruction 22-26, the source code instruction 22 is assigned a source code reference number 30. In the simplest case, the source code reference number 30 corresponds to a numbering of the source code instructions 22-26, such that each source code instruction 22-26 receives a unique source code reference number 30.

FIG. 5 shows an intermediate code instruction 31 in the intermediate language as part of the intermediate code 19 depicted in FIG. 2. The intermediate code instruction 31 corresponds to the source code instruction 22 with respect to the implemented functionality (depicted in FIG. 4). The intermediate code instruction 31 breaks down the instruction 22 into two parts 32 and 33. The first part 32 covers the addition part of the source code instruction 22 and the second part 33 covers the multiplication part of the source code instruction 22. To assign the intermediate code instruction 31 to the respective source code instruction 22, the intermediate code instruction 31 likewise includes an intermediate code reference number 34.

The source code reference number 30 and intermediate code reference number 34 need not necessarily have the same numerical value as in the depicted example, i.e., both have the value of “117.” It must be ensured, however, that each source code reference number 30 is assigned exactly one intermediate code reference number 34 and vice versa. This can be achieved particularly easily by using the same numerical value for each, or using a look-up table, for example.

In a multi-part intermediate code instruction 31, e.g., the one depicted in FIG. 5, subreferencing 35 may furthermore be useful. The subreferencing 35 may include, for example, the intermediate code reference number 34 (“117”) and the status of a counter, which is incremented for each part 32, 33 of the intermediate code instruction 31, as depicted in FIG. 5. Likewise, it may be provided that for each part 32 and 33 of the intermediate code instruction 31, a separate intermediate code reference number 34 be defined and stored, respectively. The intermediate reference numbers 34 and the source code reference number 30 belong together.

In the intermediate code instruction 31, each intermediate code parameter 36, 37, 38, 39 is equivalent to the respective source code parameter 26-28. To distinguish the intermediate code parameter from the source code parameters 26-28, the intermediate code parameters 36-39 are represented by capital letters—“A” depicted by numeric reference 36, “B” depicted by numeric reference 37, “C” depicted by numeric reference 38, “D” depicted by numeric reference 39.

For full monitoring of the execution of the intermediate code instruction 31 shown by way of example, it is necessary to log all the parameters influenced by the intermediate code instruction 31. For distinction, apart from the intermediate code parameters “A” 36, “B” 37, “C” 38, “D” 39, optional intermediate results are called indirect parameters 40. These indirect parameters 40 are identified by the Greek letter “a” and, as the only intermediate result, by the index “1.” In addition, the indirect parameters 40 include, for example, so-called flags (not depicted). They are used to store additional information generated when the individual instructions are executed. The additional information relates, for example, to a register overflow or to a non-defined result e.g., when extracting the square root of a negative number. Both types of parameters must be accessible for monitoring and therefore logged. The intermediate code parameters 36-39 and the optional indirect parameters 40 are hereinafter collectively referred to as parameters for short.

The term “executing” a source code instruction 22 or “executing” an intermediate code instruction 31, means executing the respective instruction in the control program 17, since only the control program 17 includes the actual executable code. However, since every executable instruction is based on a respective instruction in the primary code, i.e., the respective source code 22 or intermediate code instruction 31, can also be referred to as “executing” these instructions.

Logging of the parameters to be monitored is illustrated in FIG. 5 by two log instructions 41 and 42. Each part 32, 33 of the intermediate code instruction 31 is completed by a respective log instruction 41, 42. The intermediate code instruction 31 itself is therefore also completed by the log instructions 41, 42. The log instructions 41, 42, however, are not part of the intermediate code 19 but already part of the executable control program 17, since the log instructions are generated in an executable form either with or after the conversion of the intermediate code instruction 31.

Logging includes, as the character string 43, the intermediate code reference number 34 to make it possible to assign the logged parameters to the respective intermediate code instruction 31 in which the parameters were or could be influenced, the employed intermediate code parameters 36-39 and the employed intermediate result, the indirect parameter, 40.

The above description does not take into account the possibly required logging of flags. The flags, however, are logged analogously to the respectively used parameters. When an intermediate code instruction 31 is converted, it is known which flags can be influenced when the instruction is executed. For example, in the case of an addition, there is always a risk of a register overflow if the sum is greater than allowed by the width of the register in which it is to be stored. Accordingly, the flag for register overflow is logged. In a division, there is a risk of a non-defined result, i.e., in the case of a division by zero. Accordingly, in divisions, the flag for the non-defined result is logged. Overall, it is established in advance for each operation contained in an intermediate code instruction 31 which flags may be influenced when the instruction is executed. With the conversion of each operation, all the flags that can be influenced are therefore logged accordingly.

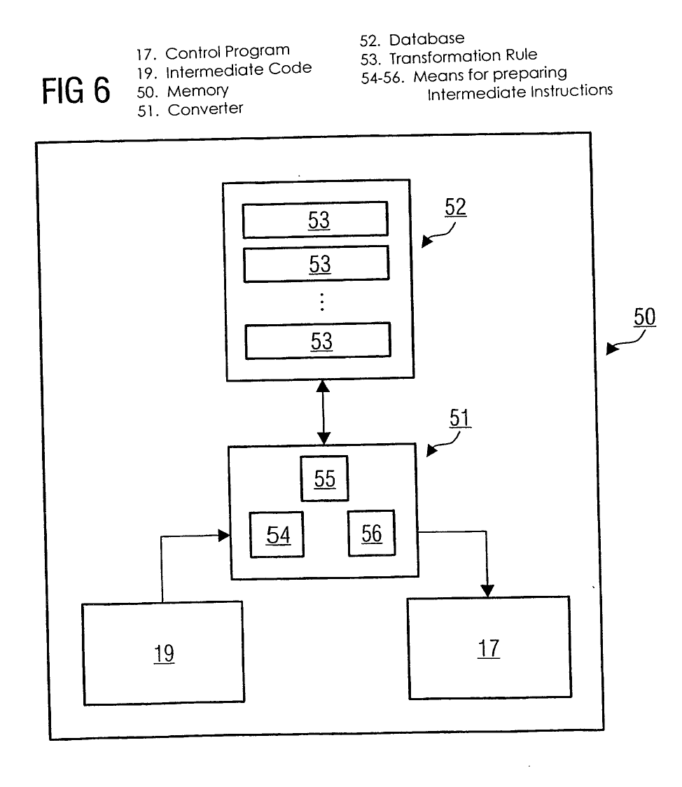

FIG. 6 shows a memory 50 of the automation device 11 representing the target hardware. The control program 17 and at least segments of the intermediate code 19 underlying the control program 17 are stored in the memory 50. The conversion 21 (depicted in FIG. 2) of the intermediate code 19 to generate the executable control program 17 is carried out using a software-implemented converter 51. This converter 51 is likewise stored in the memory 50. Alternatively, the functionality of the converter 51 can be hardware-implemented, in which case a respective ASIC, for example, (not depicted) is provided in the automation device 11.

The control program 17 is based on a primary code, corresponding to the exemplary description of the intermediate code 19, which in turn is based on the source code 18. The source code 18 includes a plurality of instructions 22-25 (depicted in FIG. 3) such that each instruction 22-25 in the source code 18 has at least one associated instruction 31 (depicted in FIG. 5) in the intermediate code 19.

To enable the control program 17 to be monitored in the above-described manner, logging is provided for each of the parameters that is or can be used and/or influenced. Logging is carried out using the log instructions 41 and 42. The log instructions 41 and 42 are generated in the conversion of each intermediate code instruction 31 and are then inserted into the control program 17 (depicted in FIG. 5).

To convert each intermediate code instruction 31 into an executable form, the converter 51 has access to a database 52. In the database, a transformation rule 53 (indicated only schematically) is stored for each permissible intermediate code instruction 31. For example, the database 52 includes a transformation rule 53 for the transformation of assign statements, a transformation rule 53 for the transformation of add statements, a transformation rule 53 for the transformation of multiply statements, etc., etc.

The converter 51 further has means 54, 55, and 56 for completing each intermediate code instruction 31 by one or more log instructions 41, 42. That is, these means 54, 55, and 56 enable logging of each parameter 36-40 that can be used and/or influenced by the intermediate code instruction.

These means 54, 55, and 56 are implemented as a software functionality or module and hence are depicted as function blocks. However, in the individual case, they may also be hardware-implemented-in the form of an ASIC (not depicted).

The means 54, 55, and 56 include first means 54 for fetching and analyzing a respective instruction of the primary code, i.e., the respective intermediate code instruction 31. To analyze each instruction, the functionality of a so-called parser is used, for example. Once the respective intermediate code instruction 31 is analyzed, it is established whether this is, for example, an instruction with an assign statement or an instruction with an add statement. Next, a second means 55 is used to fetch the respective transformation rule 53 from the database 52 and to transform the intermediate code instruction 31. This second means 55 again completes the respective intermediate code instruction 31 by logging each parameter 36-40, which can be used and/or influenced by the intermediate code instruction 31. In other words, the second means 55 completes the respective intermediate code instruction 31 by the log instructions 41 and 42 (depicted in FIG. 5). The log instructions 41 and 42 can be inserted into the control program 17 either before or after the executable counterpart of the respective instruction, depending on when a parameter 36-40 is used. In instructions with the form “A=A+B” it is furthermore useful, for example, to log the parameter “A” both before and after the instruction is executed. Finally, a third means 56 is provided to integrate the transformed i.e., the executable form of, the instruction into the control program 17 together with the log instructions 41 and 42.

When the control program 17 is run on the automation device 11, the target hardware, the added log instructions 41 and 42 are thus executed before or after each respective instruction. The parameters 36-40 thus logged are transmitted via the interfaces 13 and 14 and the data transmission link 15 to the programming device 12 the programming device 12 can display these parameters 36-40 for monitoring and diagnostic purposes together with the underlying source code 18. The logged parameters 36-40 are assigned to the original source code instructions 22-25 using the source code reference number 30 and the character string 43, which is logged by each log instruction 41, 42 and corresponds to the intermediate code reference number 34.

To identify the logged individual parameters 36-40, a fixed sequence of the parameters 36-40 is provided, preferably defined by the information contained in the transformation rule 53. In other words, it is known in advance, e.g., for the first part 32 of the intermediate code instruction 31, that the first logged value represents the value of the indirect parameter 40 and thus the intermediate result of the multiplication part of the underlying source code instruction 22. Similarly, it would further be known in advance that the second and the third logged value represent the value of the intermediate code parameters “C” 38 and “D” 39 and, accordingly, the value of the respective source code parameters “c” 28 and “d” 29, etc.

If this fixed sequence in the logging of the parameters 36-40 known in advance cannot be specified or would not be meaningful, the logged data are completed by declarative identifiers, e.g., “117: α₁=12, C=2, D=6.” This results in a character sequence (string) in which “117” again represents the intermediate code reference number 34, as the character string 43. The characters (character strings) “α₁,” “C,” and “D” as declarative identifiers make it possible to assign the logged values to the parameters to be monitored. Other special characters, such as “:”, “=” and “,” are provided to format the character sequence and thus facilitate the extraction of the data contained therein.

The logged parameters 36-40 are transmitted to the interface 14 of the automation device 11. From there, the logged parameters 36-40 reach the programming device 12. If no programming device 12 is connected to the automation device 11, the logged parameters 36-40 are not transmitted, and are then logged “into a void” as it were. The programming device 12 or the automation device 11 may further include a software functionality, or a software module for activating and deactivating the logging. The activating or deactivating the logging can also be hardware-implemented, in which case a respective ASIC, for example, (not depicted) is provided.

When the programming device 12 is connected to the automation device 11, to control or limit the data volume to be transmitted via the data transmission link 15, it is preferable to provide that the transmission of the logged parameters 36-40 starts when a specifiable source code or intermediate code reference number 30, 34 is reached, and to also provide that the transmission of the logged parameters 36-40 ends when another specifiable source code or intermediate code reference number 30, 34 is reached. Consequently, it is possible to examine selected segments of the control program 17. To examine the selected segments of the control program 17, a functionality is provided (not depicted). For example, this functionality can be a part of the interface 14 or the associated interface connection. This functionality causes the logged parameters 36-40 to be filtered such that only the parameters 36-40 logged for instructions that fall within the range of the specified source code or intermediate code reference numbers 30, 34 are transmitted to the programming device 12 via the interface 14.

According to the exemplary, non-limiting embodiment of the present invention, to monitor the execution of a control program 17 on a target hardware, it is provided that, when the control program is generated from a primary code, i.e., a source code or an intermediate code based on the source code, each instruction of the primary code is completed by log instructions 41 and 42. The log instructions 41 and 42 cause logging of all the parameters 36-40 that can be used and/or influenced by the respective instruction. The log instructions 41 and 42 are supplemented using information which is part of a transformation rule 53 for transforming the respective instruction into an executable form. When the respective instruction is transformed into an executable form, it is known which parameters and, where applicable, which registers, flags and memory contents, 36-40 are influenced by the instruction. These parameters 36-40 and the information necessary to access them form part of the log instructions 41 and 42. This makes it possible to monitor the execution of a control program 17 by using the logged parameters 36-40 independently of the respective target hardware since the respective value of the parameters 36-40 is logged at any time and no access to the register contents of the target hardware, e.g., by way of a programming device 12, is required.

The above description of illustrative, non-limiting embodiment and variations thereof has been given by way of an example. The above and other features of the invention including various novel method steps and components have been particularly described with reference to the accompanying drawings and pointed out in the claims. It will be understood that the particular process and construction of parts embodying the invention is shown by way of an illustration only and not as a limitation of the invention. The principles and features of this invention may be employed in varied and numerous embodiments without departing from the scope of the invention as defined by the appended claims and equivalents thereof.

1. A converter for generating a control program running on a target hardware, the control program being based on a primary code with a plurality of instructions, the converter comprising:
access functionality for accessing a database in which a transformation rule is stored for each of the plurality instructions; and
means for supplementing each instruction from the plurality of instructions such that each parameter in the instruction being supplemented is logged,
wherein each parameter is at least either used or influenced by the respective instruction, and
wherein the transformation rule comprises information to supplementing the instruction with respect to the logging of the respective parameters of the instruction being supplemented.

2. The converter as claimed in claim 1, wherein each parameter is logged at least either before or after the instruction is executed.

3. The converter as claimed in claim 2, wherein the primary code is a source code underlying the control program with a plurality of source code instructions and wherein the instruction is the source code instruction.

4. The converter as claimed in claim 2, wherein the control program is based on an intermediate code with respective intermediate code instructions, wherein the intermediate code is based on a source code with a plurality of source code instructions, and wherein the primary code is the intermediate code, and the instruction is the intermediate code instruction.

5. The converter as claimed in claim 2, wherein, apart from each parameter, a reference uniquely assigned to the respective instruction is logged.

6. The converter as claimed in claim 1, wherein the primary code is a source code underlying the control program with a plurality of source code instructions and wherein the instruction is the source code instruction.

7. The converter as claimed in claim 6, wherein, apart from each parameter, a reference uniquely assigned to the respective instruction is logged.

8. The converter as claimed in claim 1, wherein the control program is based on an intermediate code with respective intermediate code instructions, wherein the intermediate code is based on a source code with a plurality of source code instructions, and wherein the primary code is the intermediate code, and the instruction is the intermediate code instruction.

9. The converter as claimed in claim 8, wherein, apart from each parameter, a reference uniquely assigned to the respective instruction is logged.

10. The converter as claimed in claim 1, wherein, apart from each parameter, a reference uniquely assigned to the respective instruction is logged.

11. An automation device for generating a control program running on a target hardware, the control program is based on a primary code with a plurality of instructions, the automation device comprising:
a converter, which accesses a database in which a transformation rule is stored for each of the plurality instructions;
wherein the converter supplements each instruction such that each parameter in the instruction is logged,
wherein each parameter is used and/or influenced by the respective instruction, and
wherein the transformation rule comprises information for supplementing the instruction with respect to the logging of the respective parameters of the instruction.

12. The automation device as claimed in claim 11, further comprising functionality for activating and deactivating the logging.

13. A development environment comprising:
an automation device for generating a control program running on a target hardware, the control program is based on a primary code with a plurality of instructions and each of the plurality instructions is supplemented by logging respective parameters at least either used or influenced by the respective instruction; and
a monitoring device displaying the logged parameters,
wherein the automation device and the monitoring device comprise a respective interface, and
wherein a data transmission link connects the interfaces of the two devices and via the data transmission link the logged parameters are transmitted to the monitoring device for display.

14. The development environment as claimed in claim 13, wherein the monitoring device comprises means for activating and deactivating the logging.

15. The development environment as claimed in claim 13, further comprising a database storing a plurality of transformation rules for each of the plurality instructions, wherein the automation device fetches an instruction from the plurality of instructions, analyzes the instruction, fetches a respective transformation rule from the plurality of transformation rules stored in the database, integrates the functionality of the instruction with log instructions for logging the respective parameters of the instruction based on the transformation rules.

16. The development environment according to claim 15, wherein at least some of the logged parameters are intermediate, indirect parameters.

17. The development environment according to claim 15, wherein the logging of the parameters is independent from the target hardware.

18. The development environment according to claim 15, wherein the control program is based on an intermediate code with respective intermediate code instructions, wherein the intermediate code is based on a source code with a plurality of source code instructions, and wherein the primary code is the intermediate code, and the instruction is the intermediate code instruction.

19. The development environment according to claim 18, wherein source code instruction is segmented and represented by at least two of the intermediate code instructions.
